(19) United States
(12) Patent Application Publication
(10) Pub. No.: US 2010/0154576 A1
(43) Pub. Date: Jun. 24, 2010

(54) SHIFT ARRANGEMENT

(75) Inventors: Horst LEICHSENRING, Hohentengen (DE); Heinz REICHERT, Markdorf (DE); Sylva ROTHER, Kressbronn (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/613,573

(22) Filed: Nov. 6, 2009

(30) Foreign Application Priority Data
Dec. 19, 2008 (DE) 10 2008 054 977.0

(51) Int. Cl. F16H 61/30

(52) U.S. Cl. 74/473.11

(57) ABSTRACT

A shift arrangement for shifting a transfer case in a main transmission for an all-wheel-drive vehicle, having at least one actuated shift device such that the shift device can be hydraulically actuated by at least one piston (1) which can move in a cylinder (2) between various shift positions (2WD/high, 4WD/high, 4WD/low).

This application claims priority from German patent application serial no. 10 2008 054 977.0 filed Dec. 19, 2008.

### FIELD OF THE INVENTION

The present invention concerns a shift arrangement for shifting a transfer case provided in a main transmission for an all-wheel-drive vehicle.

### BACKGROUND OF THE INVENTION

For example, from the document DE 602 04 624 T2 a shift control system for a transfer case of a vehicle is known. The transfer case comprises a controllable two-way clutch arrangement, such that the shift system actuates the clutch arrangement in order to produce various speed ranges and drive modes. To control the shifting of the clutch arrangement between its individual modes, an electrically operated actuator is used in the shift system.

Thus, in known shift arrangements the shift between two-wheel and four-wheel drive and between different transmission ratios takes place by means of an electric motor, which actuates the shift mechanism accordingly. However, actuation by an electric motor has the disadvantage that the necessary electronics are as a rule complex and cost-intensive to produce, as well as prone to failure. Moreover, a high transmission ratio is needed in order to produce a sufficient shifting force for the synchronization between two-wheel and four-wheel drive.

### SUMMARY OF THE INVENTION

Accordingly, the purpose of the present invention is to propose a shift arrangement for shifting a transfer case provided in a main transmission for an all-wheel-drive vehicle of the type described at the start, in which the shift device can be actuated in a very simple manner with as few components as possible, and therefore inexpensively.

Thus, a shift arrangement is proposed for shifting a transfer case provided in a main transmission of an all-wheel-drive vehicle, with at least one shift device or suchlike that can be actuated, such that to set various shift positions the shift device can be actuated hydraulically by at least one piston or suchlike which can move in a housing or cylinder. In this way, by virtue of the hydraulic system used large shifting forces and particularly short shifting times can be achieved for actuating the shift device and therefore the transfer case. Furthermore, in the shift arrangement according to the invention the use of a single piston involves only robust and simply designed components, which ensures low-maintenance and more reliable operation.

In a particularly advantageous embodiment variant of the present invention the piston can be controlled by at least two multi-way valves or the like, which are supplied from a pressure medium supply of the main transmission. In this way the already present hydraulic system of the main transmission can be used to control the all-wheel transfer box as well. Owing to the simple structure of the control system, simple valves can advantageously be used for controlling the piston.

In the hydraulic shifting system for the integrated all-wheel transfer case proposed by the invention, the piston can for example be in active connection, via a cam plate or the like, with shift forks of the shifting device, so that the translational movement of the piston is transmitted by a connecting pin in a recess of the cam plate, to activate the shift forks in order to actuate, for example, a synchronizing clutch for changing between two-wheel and four-wheel drive and to actuate a claw clutch or suchlike in order to obtain a desired transmission ratio. Other designs of the shift device are also possible, which can be activated by the shift arrangement according to the invention.

According to a related design of the present invention, as the multi-way valves at least a first 2-way valve and a second 2-way valve can be provided. Other valve types too can be used to produce the desired shift positions for actuating the shift device. For example, even a single valve of more complex design can replace the two simple valves proposed.

Preferably, a first shift position corresponds to the basic position of the two 2-way valves, such that in this first shift position the piston is at its end position on the right in the inside space of the cylinder. This can be achieved for example by admitting the pressure medium from the pressure medium supply of the main transmission, via the pressure medium connections of the two 2-way valves, into the inside space of the cylinder on the left, in order to move the piston to its end position on the right and if necessary hold it there.

A second shift position, in which for example the piston is in a central location in the inside space of the cylinder, can be produced by displacing the first 2-way valve relative to the second 2-way valve in such manner that, via the pressure medium connections, the pressure medium can be passed both into the inside cylinder space on the left and into the inside cylinder space on the right, in order to move the piston to the central position and if necessary hold it there.

Finally, a third shift position in which the piston is in an end position on the left in the inside space of the cylinder can be produced by also displacing the second 2-way valve so that, via the pressure medium connections, the pressure medium can be passed into the inside space of the cylinder on the right, in order to move the piston to its end position on the left and if necessary hold the piston there.

To hold the piston in one of the above positions, it can be provided for example that mechanical detent means or suchlike are arranged on the cam plate. This has the advantage that the hydraulic control can be switched without pressure. Advantageously, the detent means provided can be combined with an additional multi-way valve for switching on and off the pressure supply that actuates the shift device. Preferably, the additional multi-way valve can be connected upstream from the other multi-way valves so as thereby to switch off the pressure medium supply for the first and second 2-way valves when no shifting of the shift device is needed. In this way the entire hydraulic shift system can be depressurized, so that unnecessary leaks and component loading are avoided.

To enable the position of the shift device to be determined at any time, for example a sensor or suchlike can be provided in order to detect a rotation angle on the cam plate.

### BRIEF DESCRIPTION OF THE DRAWINGS

Below, the present invention is described in greater detail with reference to the drawings, which show:

FIG. 1: Schematic view of a possible embodiment variant of a shift arrangement according to the invention, in a first shift position;

FIG. 1A: Schematic view of another embodiment variant of a shift arrangement according to the invention, in a first shift position;

FIG. 2: Sectioned view along the line A-A in FIG. 1;

FIG. 3: Schematic view of the shift arrangement according to the invention, in a second shift position;

FIG. 4: Sectioned view along the line A-A in FIG. 3;

FIG. 5: Schematic view of the shift arrangement according to the invention, in a third shift position; and

FIG. 6: Sectioned view along the line A-A in FIG. 5.

### DETAILED DESCRIPTION OF THE PREFERRED EMBODIMENTS

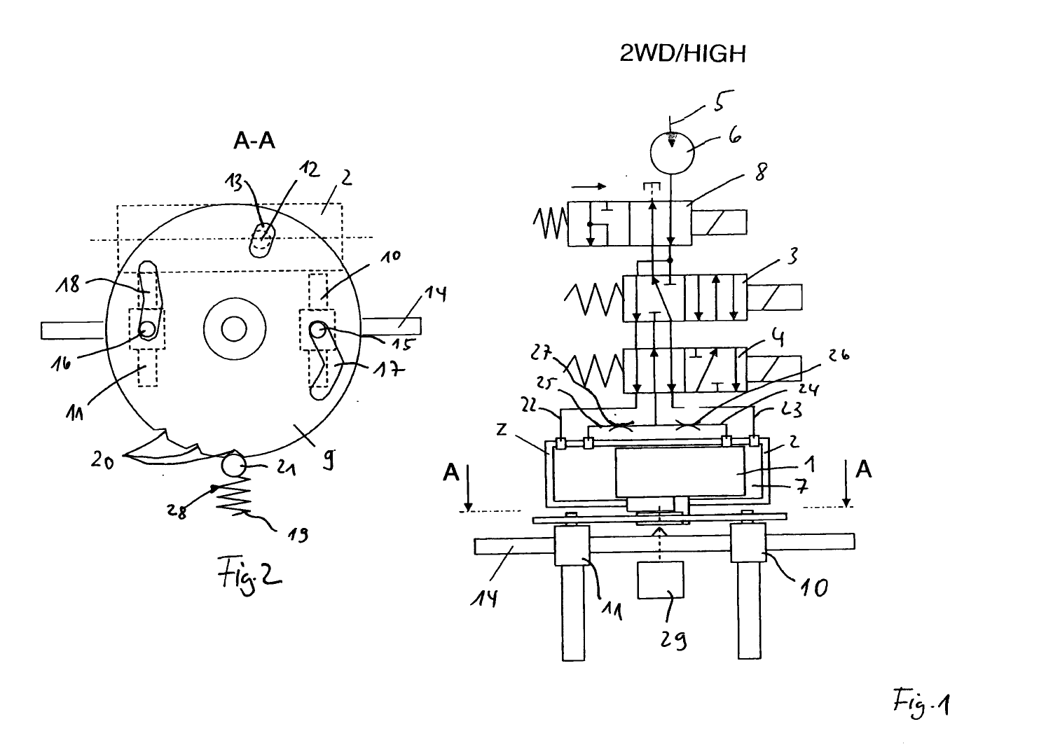

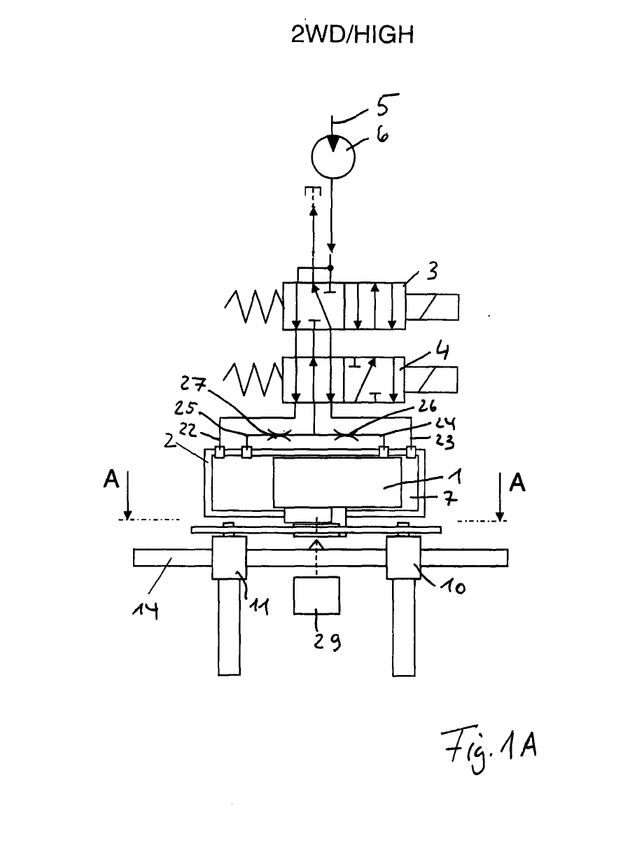

FIGS. 1 and 1A show, as examples, two different embodiment variants of a shift arrangement according to the invention, in a first shift position 2WD/high. The other figures, FIGS. 2 to 6, show the shift arrangement in the embodiment variant according to FIG. 1, in the other possible shift positions 4WD/high and 4WD/low of the shift device.

Regardless of the particular embodiment variant, the shift arrangement according to the invention comprises an actuated shift device with which a transfer case provided in a main transmission for an all-wheel-drive vehicle can be shifted. To actuate the shift device a hydraulically operated actuator is provided, which essentially consists of a piston 1 arranged to move in a cylinder 2.

For hydraulic actuation of the piston 1, it is coupled via a first 2-way valve 3 and a second 2-way valve 4 to a pressure medium supply 5 of the main transmission (the latter is not shown). The pressure medium supply 5 comprises, among other things, a pressure medium pump 6. By means of the two 2-way valves 3, 4 the inside space 7 of the cylinder in which the piston 1 moves is fed with pressure medium as appropriately for the shift position desired, so as to be able to produce the three different shift positions 2WD/high, 4WD/high and 4WD/low of the shift device which correspond to the piston 1 in its end positions and its central position.

In contrast to the embodiment variant shown in FIG. 1A, in the variant shown in FIG. 1 a further 2-way valve 8 is provided in order to enable the pressure medium supply 5 that actuates the shift device to be switched on and off. For that purpose the additional 2-way valve 8 is connected upstream from the two 2-way valves 3, 4. In this way the complete shift arrangement can be depressurized when no change of shift positions is wanted. The additional 2-way valve 8 is also present in the shift arrangements shown in the other figures, FIGS. 2 to 6, but the additional 2-way valve 8 can alternatively be omitted, although for the sake of simplicity this is not shown.

The piston 1 is actively connected, via a cam plate 9, to a first shift fork 10 and a second shift fork 11. The translational movement of the piston 1 is converted by a connecting pin 12 in a slot 13 of the cam plate 9 into rotational movement of the cam plate 9. The two shift forks 10, 11 are mounted to move axially on a guide-rod 14. In this way the cam plate 9, depending on its rotation angle, can actuate the respective shift fork 10, 11 so as to shift the transfer case to change between a two-wheel-drive mode without a crawling gear ratio (2WD/high) and a four-wheel-drive mode without a crawling gear ratio (4WD/high), with an additional change of the transmission ratio for example to a crawling gear in the four-wheel-drive mode (4WD/low). To switch over between the two-wheel-drive (2WD/high) and the four-wheel-drive (4WD/high) modes, a synchronizing clutch can be actuated by the associated first shift fork 10. To change the transmission ratio (to 4WD/low), a claw clutch can be actuated by the associated second shift fork 11 (these two clutches are not shown in the figures, since the proposed actuation method is independent of the respective design of the shift device).

The corresponding movement of the shift forks 10, 11 in accordance with the rotation angle of the cam plate 9 is made possible on the cam plate 9 in that the shift forks 10, 11 are guided by corresponding pins 15, 16 in associated guide-slots 17, 18 of the cam plate 9, so that the rotation movement of the cam plate 9 produces a corresponding axial movement of the shift forks 10, 11 along the guide-rod 14.

To hold the cam plate 9 in its respective shift position, mechanical detent means 28 are provided. These detent means 28 consist of a ball 21 held by a compression spring 19 in corresponding notches 20, the respective notches 20 corresponding to the respective shift positions of the piston 1, so that the position of the cam plate 9 is mechanically fixed by the detent means 28. In this condition the pressure medium supply 5 can be disconnected by the additional 2-way valve so that the shift arrangement is not pressurized, since the cam plate 9 and hence also the shift forks 10, 11 are held in position by the detent means 28. The additional 2-way valve 8 can for example be actuated electrically to move it between the positions for connecting and disconnecting the pressure medium supply 5. When the desired shift position has been reached, the additional 2-way valve can be moved in the direction of the arrow in FIGS. 1, 3 and 5 in order to disconnect the pressure medium supply 5. Other actuation methods are also possible.

As shown in FIG. 1, the first shift position 2WD/high is reached when the additional 2-way valve 8 connects the pressure medium supply 5 with the first and second 2-way valves in their rest position, so that the pressure medium connections of the two 2-way valves 3, 4 correspond with one another in such manner that pressure medium from the pressure medium supply 5 of the main transmission is fed, via a pressure medium line 22, into the left-hand side of the inside space 7 of the cylinder, so that under the action of the pressure medium the piston 1 moves to its end position on the right in the inside space 7 of the cylinder. This first shift position 2WD/high corresponds to the position of the cam plate 9 shown in FIG. 2 and the shift forks 10, 11 in active connection with it, to provide two-wheel drive for the vehicle without engaging a crawling gear transmission ratio.

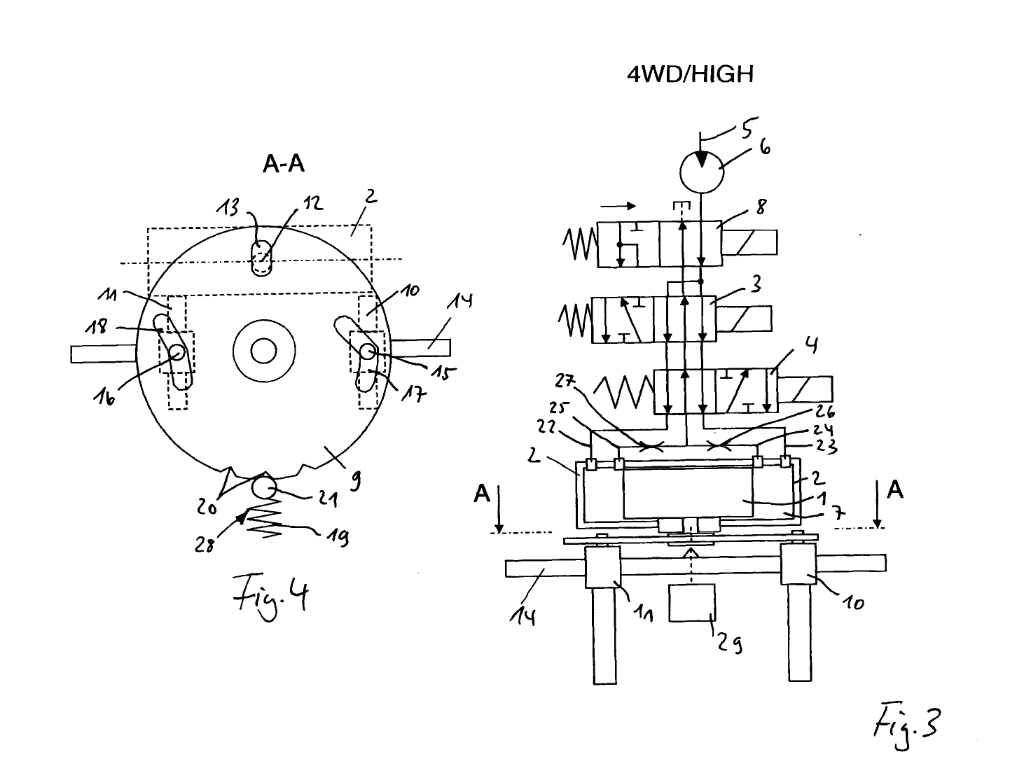

In FIG. 3 the shift device is shown in a second shift position 4WD/high, in which the piston 1 is in a central position in the inside space 7 of the cylinder. To produce this second shift position 4WD/high, pressure medium from the pressure medium supply 5 of the main transmission is passed by the connecting, additional 2-way valve 8 to the two 2-way valves 3, 4. In this second shift position 4WD/high the first 2-way valve 3 must be displaced in such manner that the pressure medium connections of the two 2-way valves 3, 4 correspond with one another so that pressure medium passes both through the pressure medium line 22 into the left-hand part of the inside space 7 of the cylinder and also through a pressure medium line 23 into the right-hand part of the inside space 7. The result is that the piston 1 is brought to a central position in the inside space 7 of the cylinder. This second shift position 4WD/high corresponds to a position of the cam plate 9 and the shift forks 10, 11 which is shown in FIG. 4. In the second shift position 4WD/high a four-wheel drive mode without a crawling gear transmission ratio is engaged in the transfer case or vehicle.

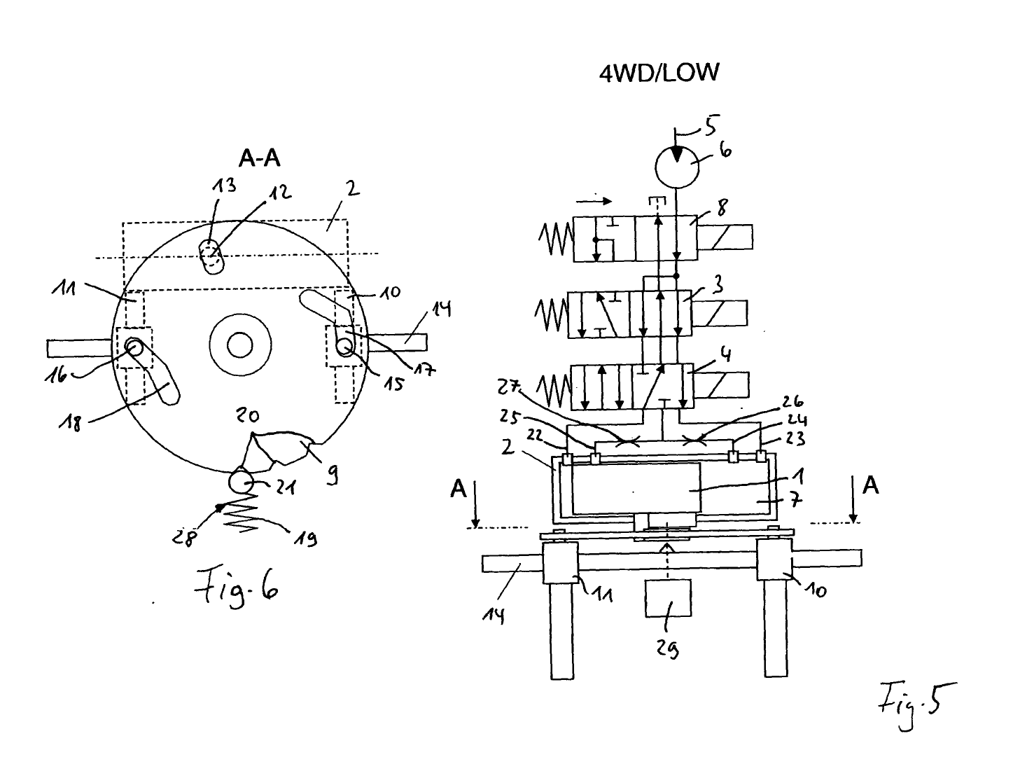

A third possible shift position 4WD/low of the shift device is shown in FIG. 5. To produce this third shift position 4WD/low the second 2-way valve 4 too is displaced so that the pressure medium connections of the two 2-way valves 3, 4 correspond in such manner that pressure medium from the pressure medium supply 5 of the main transmission passes only through the pressure medium line 23 into the right-hand part of the inside space 7 of the cylinder. The resultant action of the pressure medium moves the piston 1 to its end position on the left in the inside space 7 of the cylinder. This third shift position 4WD/low corresponds to a position of the cam plate 9 and the associated shift forks 10, 11 shown in FIG. 6. In this third position 4WD/low a four-wheel drive mode with a crawling gear transmission ratio, which enables improved off-road use of the vehicle, is engaged.

To enable the above-described shift positions 2WD/high, 4WD/high, 4WD/low to be produced by the piston 1 in the inside space 7 of the cylinder, venting lines 24, 25 are provided, each preferably fitted with a respective throttle 26, 27.

From FIGS. 1, 1A, 3 and 5 it can be seen that a sensor device 29, for example a rotation angle sensor or the like, is provided in the shift arrangement according to the invention, in order to detect the current shift position 2WD/high, 4WD/high or 4WD/low of the shift device.

### Indexes

1. Piston
2. Cylinder
3. First 2-way valve
4. Second 2-way valve
5. Pressure medium supply of the main transmission
6. Pressure medium pump
7. Inside space of the cylinder
8. Additional 2-way valve
9. Cam plate
10. First shift fork
11. Second shift fork
12. Connecting pin
13. Slot
14. Guide-rod
15. Pin
16. Pin
17. Guide-slot
18. Guide-slot
19. Compression spring
20. Notches
21. Ball
22. Pressure medium line
23. Pressure medium line
24. Venting line
25. Venting line
26. Throttle
27. Throttle
28. Detent means
29. Sensor device
2WD/high First shift position
4WD/high Second shift position
4WD/low Third shift position

1-11. (canceled)

12. A shift arrangement for shifting a transfer case provided in a main transmission of an all-wheel-drive vehicle, with at least one actuated shift device, the shift device being hydraulically actuated by at least one piston (1) that moves in a cylinder (2) to produce various shift positions (2WD/high, 4WD/high, 4WD/low).

13. The shift arrangement according to claim 12, wherein the piston (1) is controlled by at least two multi-way valves which are supplied with pressure medium from a pressure medium supply (5) of the main transmission.

14. The shift arrangement according to claim 12, wherein the piston (1) is actively connected, by a cam plate (9), to shift forks (10, 11) of the shift device such that translational movement of the piston (1) is converted, by a connecting pin (12) located in a slot (13) of the cam plate (9), into rotational movement of the cam plate (9) for controlling the shift forks (10,11) and actuating a clutch for changing between a two-wheel-drive (2WD/high) and a four-wheel-drive (4WD/high) and to actuate a claw clutch for engaging a desired transmission ratio (4WD/low).

15. The shift arrangement according to claim 13, wherein the multi-way valves are at least a first 2-way valve (3) and a second 2-way valve (4) for producing various positions of the piston (1) that correspond to the various shift positions (2WD/high, 4WD/high, 4WD/low) of the shift device.

16. The shift arrangement according to claim 15, wherein a first shift position (2WD/high) of the shift device is produced by the first and the second 2-way valves (3, 4) when arranged in their rest positions such that the pressure medium from the pressure medium supply (5) passes, via pressure medium connections of the first and the second 2-way valves (3, 4), into a left-hand part of an inside space (7) of a cylinder, thereby moving the piston (1) to an end position toward a right-hand part in the inside space (7).

17. The shift arrangement according to claim 16, wherein a second shift position (4WD/high) of the shift device is produced by displacement of the first 2-way valve (3), relative to the second 2-way valve (4), such that the pressure medium passes, via the pressure medium connections, both into the left-hand part and the right-hand part of the inside space (7) of the cylinder for moving the piston (1) to a central position in the inside space (7).

18. The shift arrangement according to claim 17, wherein a third shift position (4WD/low) of the shift device is produced by displacement of the second 2-way valve (4) such that pressure medium passes, via the pressure medium connections, into the right-hand part of the inside space (7) of the cylinder, for moving the piston (1) to an end position on the left-hand part in the inside space (7).

19. The shift arrangement according to claim 14, wherein the cam plate (9) has mechanical detent means (28).

20. The shift arrangement according to claim 14, wherein a sensor device (29) detects a rotation angle of the cam plate (9).

21. The shift arrangement according to claim 15, wherein an additional multi-way valve is provided for connecting and disconnecting the pressure medium supply (5) that actuates the shift device.

22. The shift arrangement according to claim 21, wherein the additional multi-way valve is a 2-way valve (8) which is connected upstream of the first 2-way valve (3) and the second 2-way valve (4).

23. A shift arrangement for shifting a transfer case provided in a main transmission of an all-wheel-drive vehicle, the shift arrangement having at least one actuated shift device,
wherein the shift device is hydraulically actuated, by at least one piston (1) that moves in a cylinder (2), and the shift device is capable of moving the piston (1) for achieving at least a two wheel drive high position (2WD/high), a four wheel drive high position (4WD/high) and a four wheel drive low position (4WD/low).
